(19) United States
(12) Patent Application Publication
(10) Pub. No.: US 2017/0017759 A1
(43) Pub. Date: Jan. 19, 2017

(54) COGNITIVE BEHAVIORAL THERAPY (CBT) METHOD, SYSTEM AND APPLICATION

(71) Applicant: Zansors LLC, Tysons, VA (US)

(72) Inventors: Jill MacNeice, Washington, DC (US); Noah Rosenheck, Washington, DC (US)

(21) Appl. No.: 15/212,958

(22) Filed: Jul. 18, 2016

Related U.S. Application Data
(60) Provisional application No. 62/193,419, filed on Jul. 16, 2015.

(51) Int. Cl. G06F 19/00; H04L 29/06

(52) U.S. Cl. CPC G06F 19/325; G06F 19/3406; H04L 63/102

(57) ABSTRACT

A cognitive behavioral therapy (CBT) method, system and application for treating disorders/conditions such as e.g., insomnia, smoking cessation, alcohol addiction, depression, and nightmares, among others.

### CROSS REFERENCE TO RELATED APPLICATION

This application claims priority to U.S. Provisional Application Ser. No. 62/193,419, filed Jul. 16, 2015, the entirety of which is incorporated herein by reference.

### FIELD OF THE INVENTION

Embodiments disclosed herein provide a cognitive behavioral therapy (CBT) method, system and application for treating disorders/conditions such as e.g., insomnia, smoking cessation, alcohol addiction, depression, and nightmares, among others.

### BACKGROUND

As used herein, “traditional therapy” is defined by the following case study steps for a patient dealing with a disorder:
In episodic care, a patient has not seen a doctor for treatment for many months, yet the patient has many thoughts and symptoms that are not captured or the doctor must ask about and record using the rudimentary pen and paper technique.
The patient has to call the doctor's office, wait on the phone, and get an appointment typically weeks after the call.
The patient has to fill out many forms because of HIPAA laws; sometimes the patient fills out surveys/questionnaires, which are evidence-based screening tools, to rule out other disorders (e.g. restless leg syndrome, sleep apnea) in order to diagnose/treat the reason for visit (e.g., insomnia).
The patient has to wait long time in waiting room.
The patient is seen by a nurse or doctor to get his/her vital signs.
The doctor finally meets the patient who starts by asking many questions to get qualitative measures and objective measures.
The doctor asks the patient to review surveys/questionnaires and then needs time to score the answers.
The doctor decides to treat the patient with a CBT method, which is module-based—meaning usually in weekly or 2-week intervals; CBT can be face-to-face, telephone, or via a web portal. This, however, places a heavy burden on the patient to come to the office weekly for “face to face therapy.” Places a burden on patient to call-in as part of “phone CBT therapy” or places a burden on patient to use a web/Internet based CBT; assuming that the patient has broadband access.
The patient wishes to accelerate the program, rather than have it drag on for 6-8 weeks.
The patient is left “lost” needing a guide or a Sherpa on days when patient cannot see his/her physician/nurse; patient cannot share information with the care coordination team (doctor, nurse, psychologist, physical therapist).

As can be seen, the traditional therapy methodology is slow, inefficient and does not provide the patient with the ability to accelerate its CBT program. Accordingly, there is a need and desire to provide the patient with a better CBT program, from initial diagnosis through the treatment plan, which is flexible to meet the patient's needs. Moreover, with the existence of wearable and other portable patient monitoring devices, there is a need and desire to automatically input data from these devices to better determine the health of the patient and status of the patient's treatment.

### SUMMARY

Embodiments disclosed herein combine therapy and/or treatment with the full, dynamic features of a mobile device (e.g., smartphone or tablet).

The principles disclosed herein provide an alternative and much better CBT method than the traditional therapy experience discussed above. The principles disclosed herein are designed to allow a potential patient the ability to obtain CBT for a disorder/condition using a mobile device (i.e., his/her smartphone or tablet) running an application comprising the disclosed principles. For example, appointments can be scheduled using the mobile device via the disclosed application. The application will allow the patient to fill-out online surveys and other forms to provide an online pre-screening of the patient's reason for a visit or CBT (thus, using more of the face time with a doctor for treatment rather than paperwork). Wearable devices implementing health monitoring sensors could be used to feed the patient's vital signs to the application and thus wirelessly to the doctor or nurse (saving time). Once a CBT program is initiated, the application can guide the patient through the CBT and record the progress, to name a few features of the disclosed principles.

In one embodiment, a computer implemented method for implementing cognitive behavioral therapy (CBT) for a patient is provided. The method comprises inputting a patient profile via an application executing on a processor of a patient device, said application being adapted to input data directly from the patient and from one or more wearable electronic devices associated with the patient; analyzing the profile to generate a CBT plan for the patient; monitoring patient data and other input data obtained as the patient implements the CBT plan to determine a status of the CBT plan; and determining if the CBT requires adjustment based on the monitored patient data and other input data.

In another embodiment, a system for implementing cognitive behavioral therapy (CBT) for treating a patient is provided. The system comprises an application program to be executed by a processor of a patient device, said application being adapted to: input a patient profile by inputting data directly from the patient and from one or more wearable electronic devices associated with the patient; analyze the profile to generate a CBT plan for the patient; monitor patient data and other input data obtained as the patient implements the CBT plan to determine a status of the CBT plan; and determine if the CBT requires adjustment based on the monitored patient data and other input data.

### BRIEF DESCRIPTION OF THE DRAWINGS

FIG. 1 illustrates an example processing flow performed by an embodiment disclosed herein.

FIG. 2 illustrates an example processing flow performed by an embodiment used for CBT for insomnia.

FIG. 3 illustrates an example processing flow performed by an embodiment used for CBT for smoking.

FIG. 4 illustrates an example system for implementing the disclosed application and method in accordance with the disclosed principles.

FIGS. 5-9 illustrate example screenshots and functionality provided by the disclosed CBT application when used to treat insomnia in accordance with the disclosed principles.

FIGS. 10-14 illustrate example screenshots and functionality provided by the disclosed CBT application when used for smoking cessation in accordance with the disclosed principles.

### DETAILED DESCRIPTION

In this disclosure the term patient, user or client maybe used interchangeably as a person or persons seeking treatment for a disorder/condition or disease that can be treated by a CBT program.

Accordingly, in one embodiment, the principles disclosed herein can provide a flexible therapy/treatment for a patient's disorder/condition via an application running on the patient's mobile device. The application is evidence-based (i.e., proven in the clinical world with efficacy and/or effectiveness data). To build such an application, in one embodiment, booklets/programs that are used in traditional face-to-face sessions/hospitals/clinics are converted and stored in one or more databases accessible by or stored on the mobile device. In one embodiment, an information architect is used to interview the clinician and maintain the integrity of the treatment program while also keeping the special healthcare “tone and voice.” It should be appreciated that the format of a graphical user interface operated by the application is a complicated issue because of the device's small screen size. Moreover, the application will be able to communicate with a mobile health cloud system so a care coordination team can monitor and track the patient's treatment, and be a risk-detection platform.

The disclosed principles will convert the traditional therapy into a simple and more enjoyable experience that will allow patients a better opportunity to obtain and follow-through on a prescribed therapy:

TABLE 1
Improvements over traditional therapy

| From this | To This |
|---|---|
| Linear, paper based | Random access |
| Desk experience, face to face | Anywhere experience |
| Rely on recall | Triggered by life action |
| Start with lessons | Start with an activity |
| Rely on user motivation | Supplements motivation with |
| | device capabilities (reminders, |
| | gamifications, visualizations) |

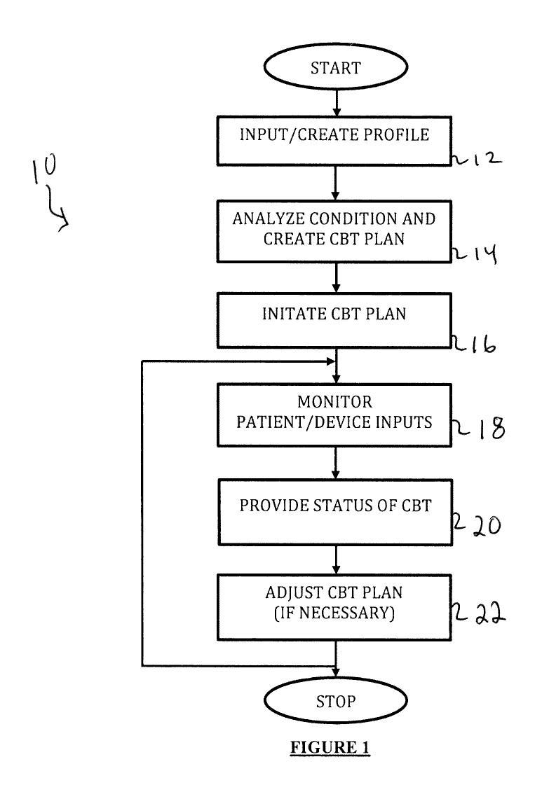

In one example embodiment, and in reference to FIG. 1, a patient uses the disclosed application or activates the application by going through its different sections to perform CBT processing 10 as follows.

The patient fills out a profile section on the application so that that application captures a baseline and rules out other diseases/disorders/conditions not related to the patient's current disease/disorder/condition (step 12). This can be a questionnaire provided by the application that is already established and used by the clinic (digitized and available to the mobile device), which can be scored based on the patient's answers. Alternatively, or in addition to, the application can co-create with the patient a plan on how to treat the patient's disorder, etc. (e.g., stop smoking). For a smoker wishing to stop smoking, a profile can be used to determine the type of smoker the patient is and to set up a preliminary goal/plan to cease smoking. Accordingly, based on the patient's input information and/or information input by one or more devices connected to or worn by the patient, the process 10 analyzes the patient's condition (step 14). In addition, the disclosed principles can create a “My Plan” which gathers results of activities and questionnaires into a personalized plan. At this point, the patient's CBT is initiated (step 16).

At this point, the disclosed application can monitor inputs from the patient and/or one or more devices connected to or worn by the patient (step 18). The patient can track its habit (e.g., sleep, smoking, etc.) by using a calendar function on the mobile device, which can be input into the disclosed CBT application. For example, for a sleeping disorder, the times in which the patient slept and woke up can be entered and the application can do calculations to obtain metrics such as e.g., sleep efficiency or time in bed (that can be charted)

The disclosed CBT application can allow the patient to journal and write narrative comments (e.g., the patient can use its phone to capture behaviors and events that may influence the therapy/disease (e.g., insomnia, depression, smoking cessation)). The logs are rich in data so that the application can calculate key metrics and create visualizations from them. The logs can track the patient's CBT progress. The patient can use the mobile device's camera to take pictures of his/her health condition. The logs can capture when a patient “slips” or has a “trigger” of its bad behavior—the disclosed CBT application provides easy access to the patient so that he/she can note triggers, cravings, etc. so the application can tailor a personalized plan (e.g., an individualized quitting plan for a smoker). With this information, the process can provide the patient with status and progress of the CBT (step 22). Changes to the CBT plan can be made by the patient and/or application if needed (step 22). The process continues at step 18 until the CBT has been completed.

In one embodiment, the disclosed CBT application will have a “behavior” section that educates the patient about enhancing behaviors. The application can set goals and/or rewards for behavior changes. The application can tell what medications may help with stopping bad behavior.

In one embodiment, the disclosed CBT application will have a “cognitive” section that addresses unhelpful thinking. For example, the CBT application advises the patient of smoking dangers and how to deal with common side-effects of smoking cessation; patients can create coping responses for challenging situations and get reminders when a tough event appears.

In one embodiment, the disclosed CBT application will have a “maintenance” section that creates a personalized reference and provides tips for handling lapses. For example, the disclosed CBT application can monitor the patient and keep him/her on track; it can deal with withdrawal symptoms and side effects; and can offer tips and techniques for maintaining the therapy.

In one embodiment, the disclosed CBT application will have a “bookshelf” section that provides a central location for reference information provided by the application. The disclosed CBT application leverages the interactivity of e-health solutions, including questionnaires, checklists, as well as easy access to key content and tools, and a bookshelf for reference material. It can incorporate reminders and encouraging messaging throughout the CBT. The disclosed CBT application can integrate with Zansors sensors (e.g., sleep, breathing, EKG, etc.) for automatic loading of objective data from the sensors.

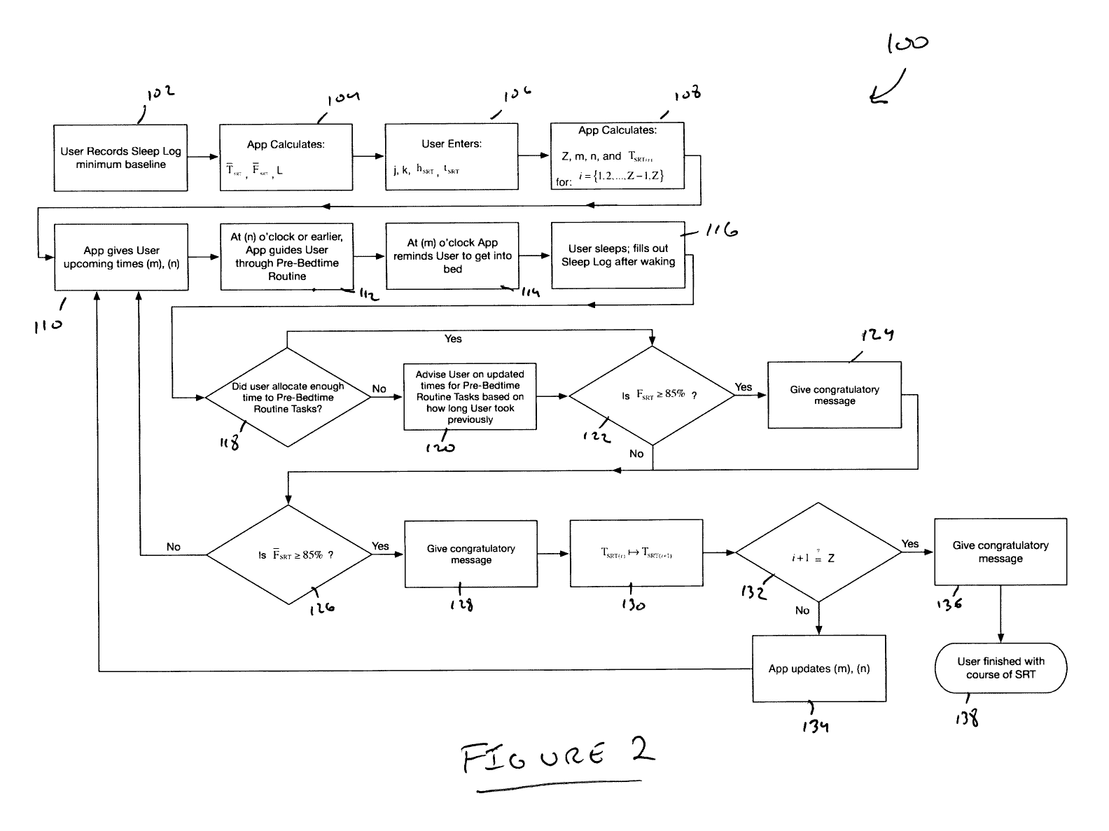

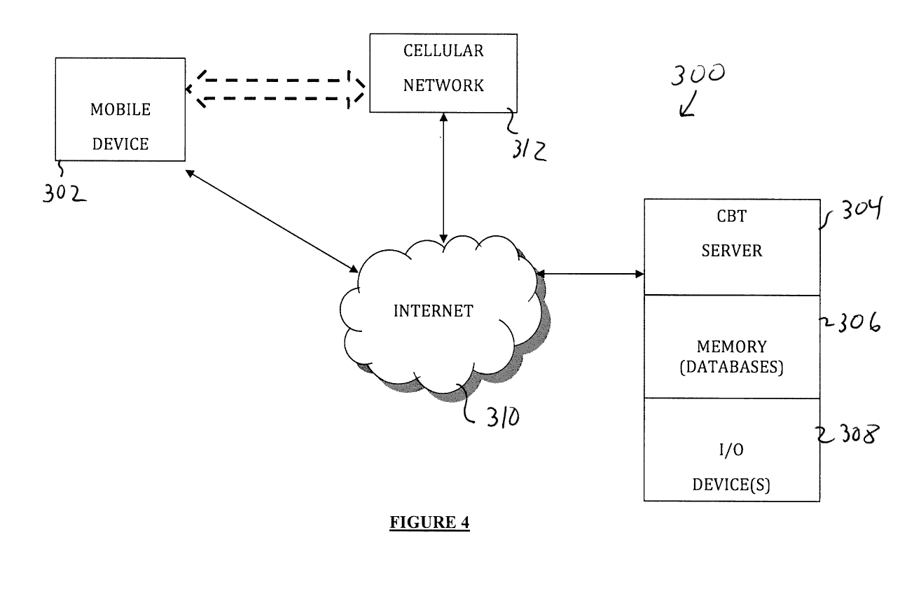

As shown in FIG. 2, the disclosed CBT application can implement CBT for insomnia. Based on data gathered by one or more processors through user and/or sensor input (e.g., see FIG. 4), the CBT application can automatically determine appropriate CBT to address the user's specific insomnia issues and modify CBT based on feedback obtained while therapy is ongoing (e.g., steps 14-22 of FIG. 1). For example, the CBT application may help users sleep better by monitoring their sleep behaviors and logs and, using an artificial intelligence process, providing recommendations for when the user should go to sleep and start their pre-bedtime time routine. The CBT application may analyze the patient's sleep logs, calculate sleep metrics, and, based on these metrics, recommend a time to go to sleep that will result in maximum sleep efficiency and, over time, longer total sleep time.

The following metrics apply to the example process of FIG. 2.

TABLE 2
Insomnia CBT Metrics

| Metric | Variable | Unit |
|---|---|---|
| Time (user) got into bed | a | Clock time |
| Time it took to fall asleep | b | Measured time |
| Number of times (user) woke up | c | Dimensionless |
| Time spent awake during the night (net/total) | d | Measured time |
| Final time (user) woke up | f | Clock time |
| Time (user) left bed | g | Clock time |
| Specified number of days (user) has logged | h | Days |
| successfully | | |

Functions:

Δt

Meaning:

How long between two times

Definition:

Δt (t₁, t₂)=The time between clock times t₁ and t₂

e.g. Δt(18:00, 19:15)=1 hour, 15 minutes=75 minutes

Time in Bed—B
Meaning:
   How long (user) was in bed (in hours and minutes or minutes)
Definition:

B=Δt(a,g)

Total Sleep Time—T
Meaning:

How long (user) was sleeping in a given night.
Definition:

$$\begin{matrix}T = B - [ b + d + Δ t ( f , g ) ] \\ = Δ t ( a , g ) - [ b + d + Δ t ( f , g ) ]\end{matrix}$$

Mean Total Sleep Time—T̅
   Meaning:
      The mean Total Sleep Time (T) for (user) over days logged (h)
   Definition:

$$\overline{T} = \frac{1}{h} ( {\sum }_{i = 1}^{h} {T}_{i} )$$

Sleep Efficiency—F
   Meaning:

How efficiently is (user) spending their time in bed? i.e. ratio of Time Asleep (T) to Time in Bed (B)
Definition:

$$\begin{matrix}F = \frac{T}{B} \\ = \frac{Δ t ( a , g ) - [ b + d + Δ t ( f , g ) ]}{Δ t ( f , g )}\end{matrix}$$

Mean Sleep Efficiency—F̅
   Meaning:
      Mean Sleep Efficiency (F̅) for (user) over days logged (h)
   Definition:

$$\overline{F} = \frac{1}{h} ( {\sum }_{i = 1}^{h} {F}_{i} )$$

The following inputs and outputs apply to the example process of FIG. 2.

Inputs:

TABLE 3
Sleep Restriction Therapy (SRT) Inputs

| Metric | Variable | Unit | (Source) |
|---|---|---|---|
| Sleep Efficiency | F | Percent | (Calculated) |
| Total Sleep Time | T | Measured time | (Calculated) |
| Target Wakeup Time | j | Clock time | (User) |
| Sleep Time Goal | k | Measured time | (User) |
| Pre-Bedtime Routine Length | L | Measured time | (Calculated) |
| Required number of days at | h | Days | (User) |
| sustained good sleep (logging | | | |
| interval) | | | |
| Sleep Extension Time Interval | t_{SRT} | Measured time | (User) |

Outputs:

TABLE 4
SRT Outputs

| Metric | Variable | (Source) |
|---|---|---|
| Restricted Bedtime | m | (Calculated) |
| Pre-Bedtime Routine Start Time | n | (Calculated) |
| Restriction/Extension Chart | (n/a) | (Calculated) |

Functions:

Trimmed Mean SRT Total Sleep Time—T̅_{SRT},

Meaning:

The average sleep time in the previous h days. The day with the lowest sleep time is omitted. We compute the mean of the remaining (h−1) days as defined below, where the T₁'s are the sleep (minutes) for the (h−1) days being counted

Note: this is used once, for the calculation of the initial restricted Sleep Time (T_{SRT(1)}.

Definition:

$${\overline{T}}_{SRT} = \frac{1}{( {h}_{SRT} - 1 )} ( {\sum }_{i = 1}^{( {h}_{SRT} - 1 )} {T}_{i} )$$

Trimmed Mean SRT Sleep Efficiency—F̅_{SRT}

Meaning:

Over D days, the lowest value of F is thrown out, and F̅_{SRT} is calculated from remaining D−1 days.

Note: this is a moving average, and is continually updated each day to include only the past D calendar days.

Definition:

$${\overline{F}}_{SRT} = \frac{1}{( {h}_{SRT} - 1 )} ( {\sum }_{i = 1}^{( {h}_{SRT} - 1 )} {F}_{i} )$$

Pre-Bedtime Routine Length—L
Meaning:

The pre-bedtime routine is a series of activities the user does before getting in bed. Its length is simply how long it will take the user to complete all activities.
Definition:

Given (x) pre-bedtime activities—each with chronological length (lᵢ),

$$L = {\sum }_{i = 1}^{x} {1}_{i}$$

Restricted Bedtime—m
Meaning:

What time to get in bed on each day of the Sleep Restriction Therapy Schedule.

Restricted bedtime starts one SRT Total Sleep Time increment (T_{SRT(i)}) before Target Wakeup Time (j).

Note: details on T_{SRT(i)} are on Calculating SRT Total Sleep Time
Definition:
   For the i^{th} day of SRT,

m=j−T_{SRT(i)}
Pre-Bedtime Routine Start—n
Meaning:

What clock-time each day of SRT that (user) should begin their Pre-Bedtime Routine in order to finish Pre-Bedtime Routine and be in bed by the Restricted Bedtime (m) of that day of SRT.
Definition:
   For the i^{th} day of SRT,

n=m−L
Restriction/Extension Chart
Definition:

The Restriction/Extension Chart is a chart that displays information and provides feedback about (users′) ongoing SRT course.

The following SRT total sleep time increment calculations apply to the example process of FIG. 2.

TABLE 5
SRT Calculation Metrics

| Metric | Variable | Unit | (Source) |
|---|---|---|---|
| Trimmed Mean SRT Total | T̅_{SRT} | Measured time | (Calculated) |
| Sleep Time | | | |
| Sleep Extension Time Interval | t_{SRT} | Measured time | (User) |
| Sleep Time Goal | k | Measured time | (User) |
| Number of Sleep Extension | Z | Dimensionless | (Calculated) |
| Intervals | | | |
| Final Sleep Extension Interval | t_{SRT(Z-1)} | Measured time | (Calculated) |

Initial Sleep Time Increment:

T_{SRT(1)}=T̅_{SRT}

Final Sleep Time:

T_{SRT(Z)}=k

Final Sleep Extension Interval:

$$\begin{matrix}{t}_{SRT ( Z - 1 )} = ( {T}_{SRT ( Z )} - {T}_{SRT ( 1 )} ) mod ( {t}_{SRT} ) \\ = ( k - {\overline{T}}_{SRT} ) mod ( {t}_{SRT} )\end{matrix}$$

Number of Sleep Extension Intervals:

$$Z = \frac{( k - ( {\overline{T}}_{SRT} + {t}_{SRT ( Z - 1 )} ) )}{{t}_{SRT}}$$

SRT Total Sleep Time increment for i={1,2, . . . , Z−1, Z}:

T_{SRT(1)}=T̅_{SRT}

T_{SRT(2)}=T_{SRT(1)}+t_{SRT}

T_{SRT(i)}=T_{SRT(1)}+(i−1)t_{SRT}

T_{SRT(Z-1)}=T_{SRT(1)}+(Z−2)t_{SRT}

T_{SRT(Z)}=T_{SRT(1)}+(Z−2)t_{SRT}+t_{SRT(Z-1)}

CBT application may receive user-entered baseline sleep log data (step 102), and CBT application may use the baseline data to calculate T(bar)_{SRT}, F(bar)_{SRT}, and L (step 104). User may enter j, k, h_{SRT}, and t_{SRT} (step 106), and T_{SRT(1)} (step 108). CBT application may give the user upcoming times (m), (n) automatically based on these calculations (step 110). At (n), CBT application may guide the user through a pre-bedtime routine (step 112). At (m), CBT application may remind the user to get into bed (step 114).

CBT application may update the CBT based on feedback. For example, when the user awakens, CBT application may receive user-entered sleep log data (step 116) and determine whether the user allocated enough time to the pre-bedtime routine tasks (step 118). If not, CBT application may determine updated pre-bedtime routine task timing based on how long user took previously and advise user of the updated times (step 120). Thereafter, or if user allocated enough time, CBT application may determine whether F_{SRT} is greater than or equal to 85% (step 122). If so, CBT application may display a congratulatory message (step 124). CBT application may determine whether F(bar)_{SRT} is greater than or equal to 85% (step 126). If not, CBT application may give user times m and n (step 110), and if so, CBT application may display a congratulatory message (step 128) and update T_{SRT(i)} to T_{SRT(i+1)} (step 130). CBT application may determine whether i+1=Z (step 132). If not, CBT application may update m and n (step 134) and give m and n to user (step 110). If so, CBT application may display a congratulatory message (step 136) and indicate that user is finished with the course of SRT (step 138).

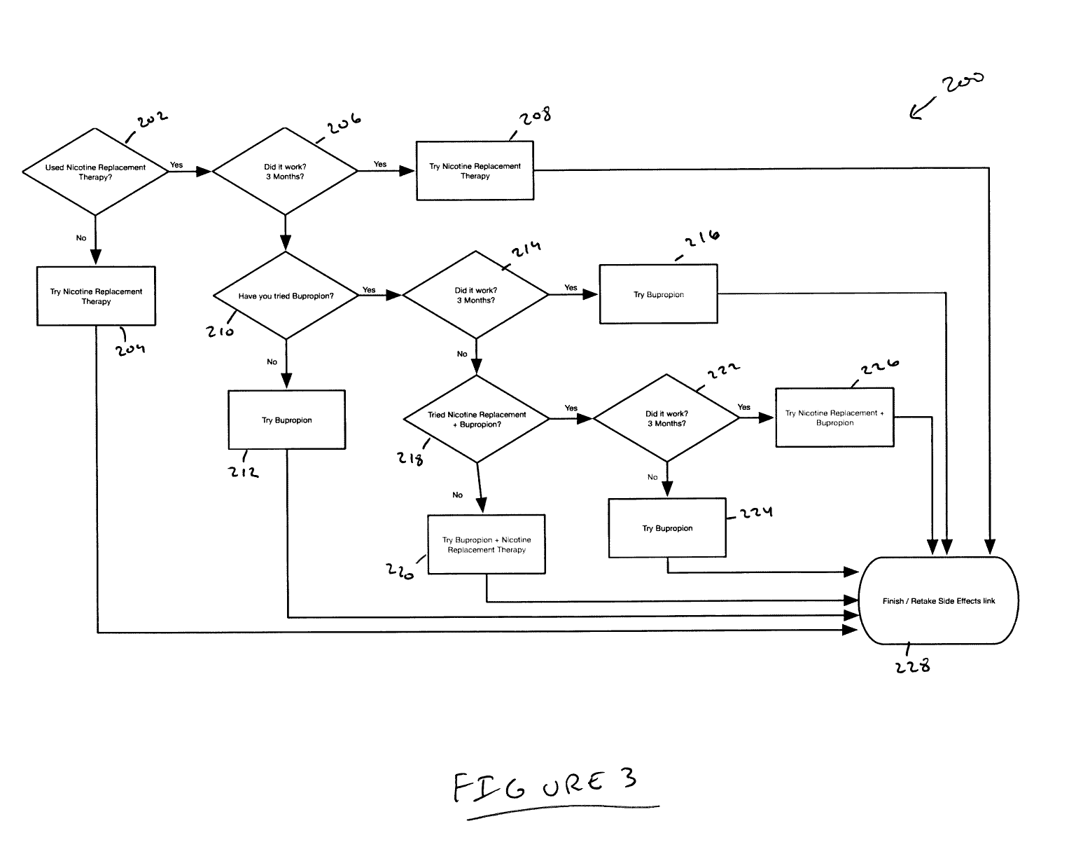

As shown in FIG. 3, the disclosed CBT application can implement CBT for smoking cessation. Based on data gathered by one or more processors through user and/or sensor input (e.g., see FIG. 4), the CBT application can automatically determine appropriate CBT to address the user's specific smoking cessation issues and modify CBT based on feedback obtained while therapy is ongoing (e.g., steps 14-22 of FIG. 1). For example, the CBT application may help users determine appropriate smoking cessation therapies based on user reporting on whether previously tried therapies and/or other behaviors improve or worsen their smoking habits.

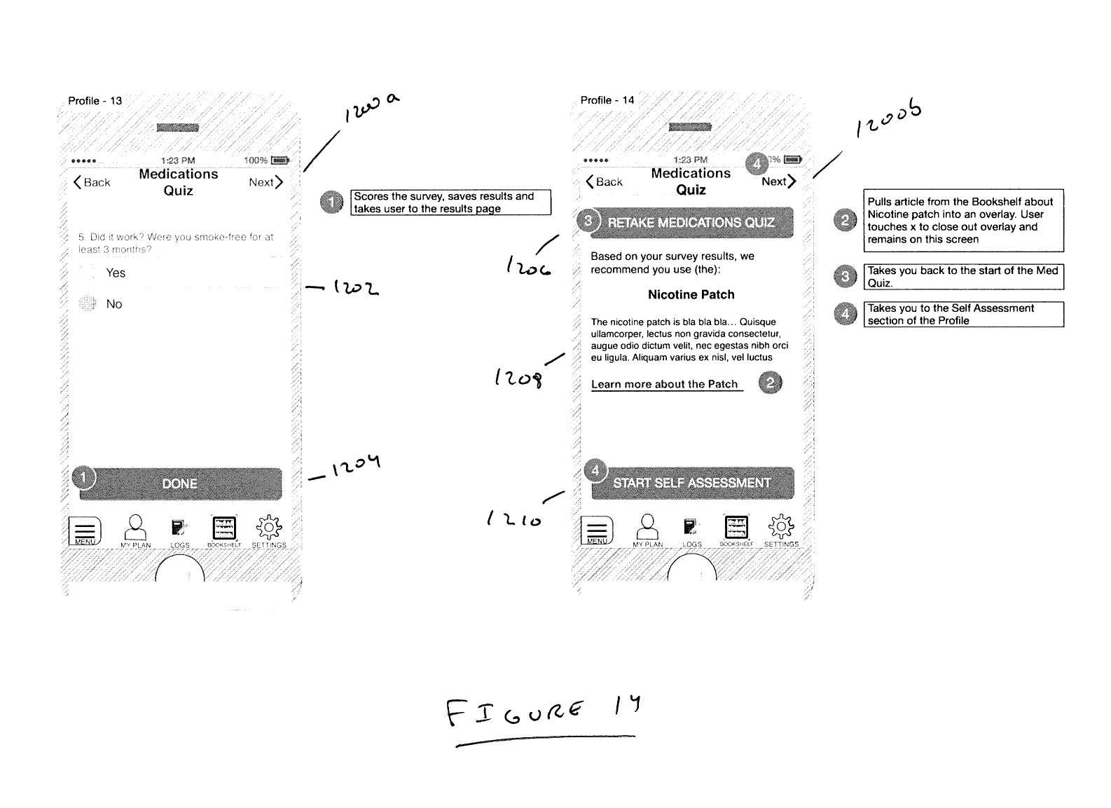

CBT application may present a survey to the user (e.g., see FIG. 14) and receive a user answer to a question, such as whether the user has tried nicotine replacement therapy (step 202). If the user has not tried the therapy, CBT application may recommend nicotine replacement therapy (step 204). If the user has tried the therapy, CBT application may determine an appropriate follow-up question, such as whether the therapy worked for three months (step 206). If it worked, CBT application may recommend nicotine replacement therapy (step 208). If it did not work, CBT application may determine another therapy to suggest, such as bupropion, and ask the user whether he or she has tried it (step 210). If not, CBT application may suggest trying bupropion (step 212). If so, CBT application may determine an appropriate follow-up question, such as whether it worked for three months (step 214). If it worked, CBT application may suggest trying bupropion (step 216). If not, CBT application may determine another therapy to suggest, such as a combination of nicotine replacement and bupropion, and ask the user whether he or she has tried it (step 218). If the user has not tried it, CBT application may recommend it (step 220). If the user has tried it, CBT application may determine an appropriate follow-up question, such as whether it worked for three months (step 222). If nicotine replacement and bupropion did not work, CBT application may recommend a different treatment, such as bupropion (step 224). If nicotine replacement and bupropion worked, CBT application may recommend it (step 226). After any recommendation, CBT application may provide a side effects link to give the user more information about the recommended therapy 228.

The example processing 100/200 of FIGS. 2 and 3 illustrate two possible use cases and therapy paths for the CBT application. However, the CBT application is flexible enough to select, monitor, and modify any type of CBT. In some cases, a single user may use the CBT application to receive CBT for multiple maladies at the same time, for example. The CBT application provides a platform that can integrate any number of CBT courses into a single interface for a user.

In one embodiment, the above described method, system and application are implemented in software (i.e., computer instructions) that are stored in a computer readable memory and executed by a processor on both a patient device and a system server. FIG. 4 illustrates an example system 300 comprising a CBT server 304 for communicating with a patient's mobile device 302 to implement the principles disclosed herein. The server 304 includes or is connected to a memory 306 for storing computer instructions required to implement portions of the methods described herein and to store the various databases, user information and login/account data used during the above-described processes. The system 300 includes a database, which may also be stored in memory 306, for user accounts, CBT pamphlet and clinical information, among other information required by the methods or applications disclosed herein. The server 304 can be accessed over a wired or wireless network 310 (shown as the Internet in this example) or via a cellular network 312.

Patient devices 302 include a mobile device (e.g., smartphone, tablet) that connects to the server 304 via the Internet/network 310 and/or a cellular network 312. The device 302 will also include a processor, memory, input/output components and other devices (e.g., camera, GPS, accelerometer, etc.) that are useful for inputting and transmitting data disclosed herein. Although not shown, the system 300 can also receive inputs from one or more devices connected to or worn by the patient (e.g., health monitors, exercise monitors, sleep monitors, sleep apnea sensors/monitors, breathing sensors, heart rate monitors).

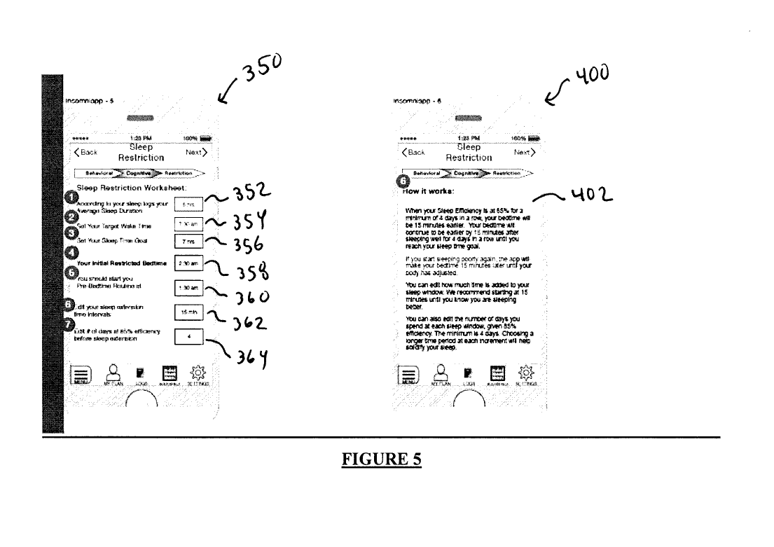

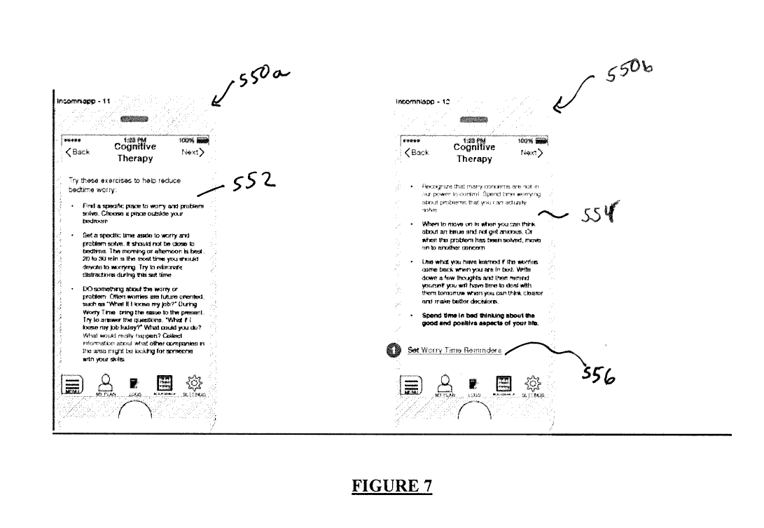

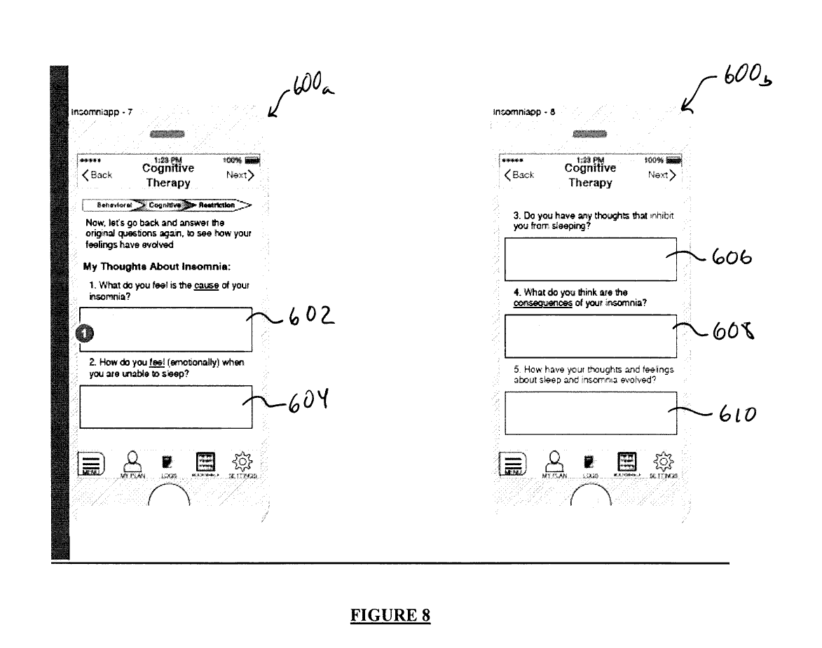

FIGS. 5-9 illustrate example screenshots and functionality of pages provided on the patient's mobile device by the disclosed CBT application when used to treat insomnia. Insomnia maybe treated by: sleep hygiene and stimulus control; optimizing the sleep environment; Adopting sleep-enhancing behaviors and avoiding sleep-disturbing behaviors; uncovering and addressing unhelpful thinking that perpetuates poor sleep; and sleep restriction and extension, leveraging the body's natural fatigue response to slowly consolidate sleep over time.

FIG. 5 illustrates two example pages 350, 400 associated with a sleep restriction functionality provided by the disclosed application (when executed on the patient's mobile device). In the first example page 350, a sleep restriction worksheet is displayed on the device. The worksheet includes a field 352 for the patient's average sleep duration. This field 352 could be populated by an input from the patient, but in one embodiment, it is automatically populated based on the patient's sleep logs entered into the application via another page of the application. For example, the application determines the average sleep duration using the formula: average time in bed for all nights logged minus average time awake. The worksheet further includes fields 354 and 356 for respectively inputting the patient's target wake time and sleep time goal. These fields 354, 356 may be populated by inputs from the patient using time picker increments (of e.g., 5, 10, 15 minutes or more) or automatically populated based on the patient's sleep logs.

Field 358 illustrates the patient's initial restricted bedtime as determined by the disclosed application based on the previously input information while field 360 provides a recommendation for when the patient should begin her/his pre-bedtime ritual (e.g., restricted bedtime minus 40 minutes). The worksheet also include fields 362, 364 allowing the patient to respectively input/edit sleep extension time intervals and the number of days the patient is at 85% efficiency before the sleep extension. Field 362 can have a default value (e.g., 20 minutes) and be changed by the patient. Field 364 can also have a default value (e.g., 4 days) and can be changed by the patient. Example page 400 illustrates a “how it works” write-up to help guide the patient through the CBT process (e.g., provides guidance on what some of the terms used in the profile and other sections mean).

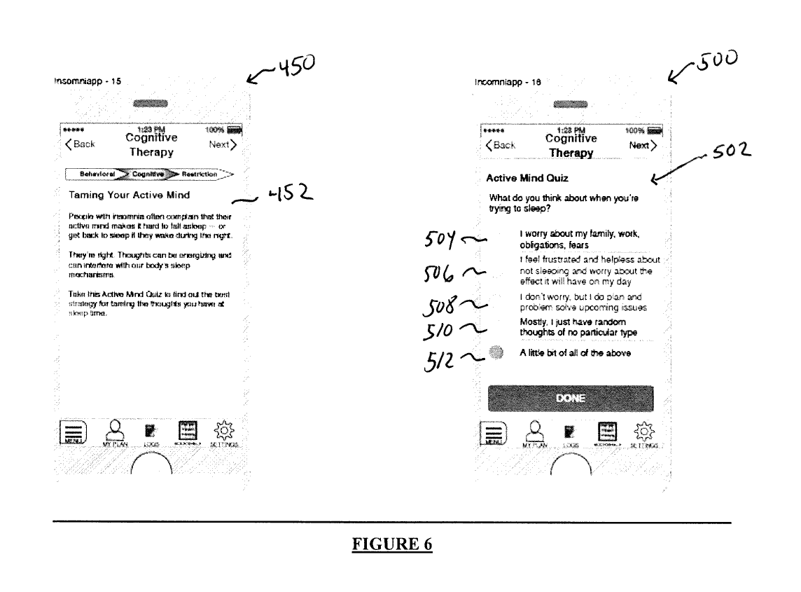

FIGS. 6-8 illustrate example pages 450, 500, 550a, 550b, 600a and 600b associated with a cognitive therapy functionality provided by the disclosed application (when executed on the patient's mobile device). Page 450, for example, provides a description entitled “Taming Your Active Mind” that encourages the patient to take an “Active Mind Quiz” to determine the best strategy for the patient to tame his/her mind before going to bed. Page 500 illustrates an example of such a quiz 502. The quiz 502 includes a question (e.g., “what do you think about when you're trying to sleep?”). Below the quiz are fields 504, 506, 508, 510, 512 containing typical responses. Field 512 (“A little bit of all of the above”) is shown as being selected by the patient.

Pages 550a, 550b provide descriptions 552, 554 entitled “Try these exercises to help reduce bedtime worry.” These descriptions 552, 554 are part of the patient's CBT. Field 556 allows the patient to set “worry time” reminders (i.e., native reminders). Pages 600a, 600b provide the patient with the opportunity to provide “My Thoughts About Insomnia” 602. These pages 600a, 600b include fields 602, 604, 606, 608, 610 for respectively inputting the patient's thoughts on: what is the cause of the insomnia; how the patient feels (emotionally) about his/her insomnia; what the patient believes is inhibiting sleep; what that consequences of the patient's insomnia are; and how the patient's thoughts regarding insomnia have evolved. It should be appreciated that the pages 450, 500, 550a, 550b, 600a and 600b associated with the cognitive therapy could include other messages and quizzes deemed appropriate for the patient's illness (insomnia in this example).

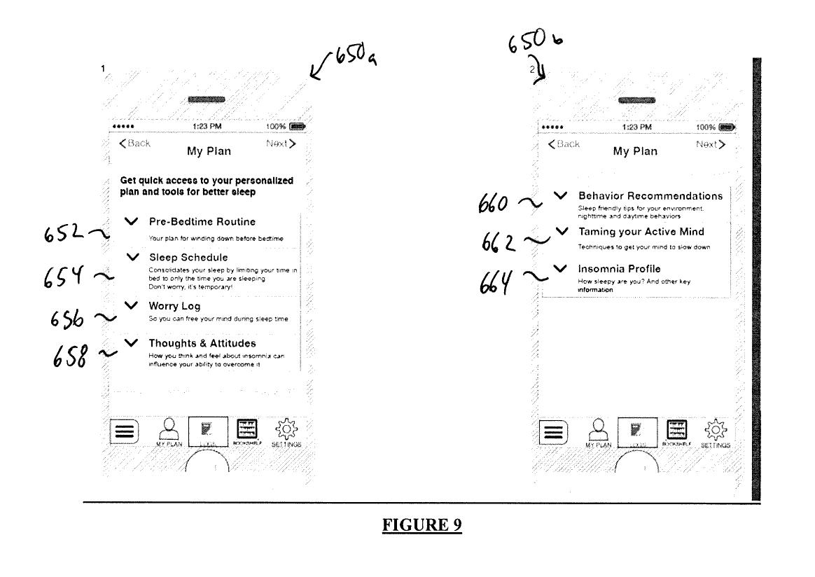

FIG. 9 illustrates pages 650a, 650b associated with the “My plan” functionality provided by the disclosed application (when executed on the patient's mobile device). In the illustrated example, the patient is capable of obtaining quick access to his/her personalized plan and tools for better sleep in accordance with the disclosed principles. In the illustrated example, the patient may select pull down menus/plans for: a pre-bedtime routine 652; sleep schedule 654; a worry log 656; thoughts and attitudes 658; behavior recommendations 660; taming your active mind 662; and an insomnia profile 664. It should be appreciated that the pages 650a, 650b associated with the patient's “My plan” could include other menus, tools and messages deemed appropriate for the patient's illness (insomnia in this example).

Accordingly, the principles disclosed herein translate an evidence-based CBT for Insomnia program into the disclosed CBT application. CBT is medically proven to be superior to drugs in treating insomnia. The disclosed CBT application can be used in conjunction with a healthcare provider or alone. Features of the disclosed CBT application for treating insomnia include: (1) a Profile section that establishes a baseline and rules out serious diseases like Apnea and Restless Leg Syndrome; (2) an ongoing sleep log that tracks sleep, along with behaviors and events that influence sleep quality and quantity, allows for narrative comments. (Studies show that journaling is beneficial for improving health outcomes.) The Application calculates key metrics and creates visualizations based on the logs; (3) a behavior section educates the patient about sleep enhancing behaviors; (4) a cognitive section addresses unhelpful thinking; and (5) a maintenance section that creates a personalized reference and provides tips for handling lapses. The CBT application leverages the interactivity of e-health solutions, including questionnaires, checklists, as well as easy access to key content and tools, and a bookshelf for reference material; incorporates reminders and encouraging messaging; and can integrate with sleep monitors for automatic loading of sleep metrics.

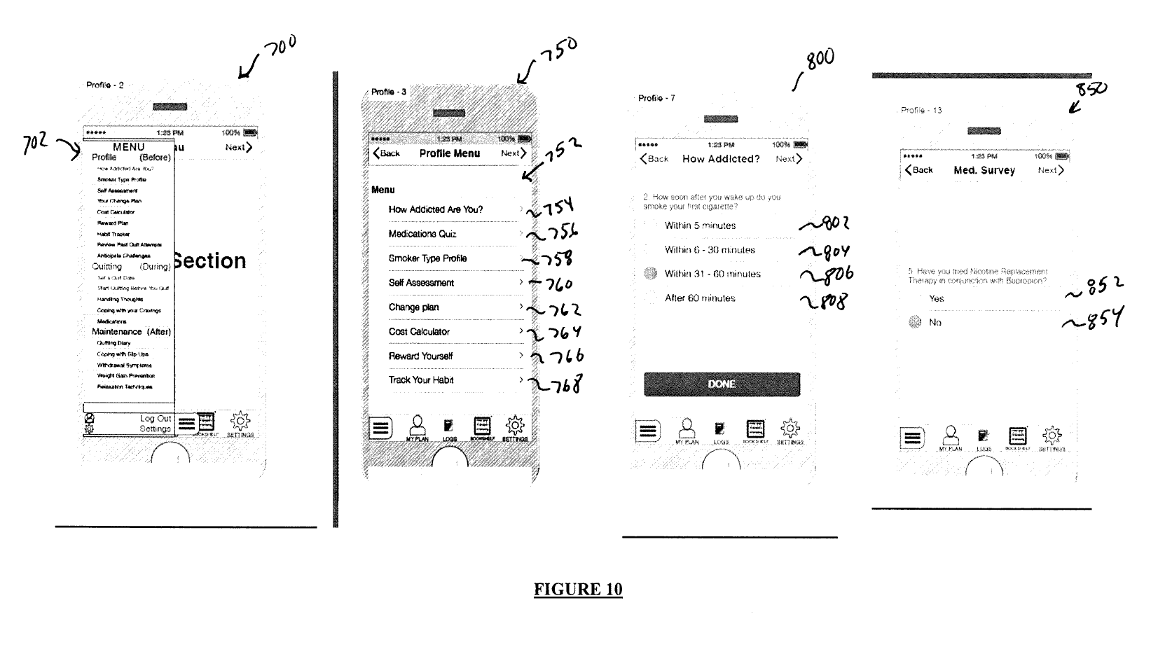

FIGS. 10-13 illustrate sample screenshots and functionality of pages provided on the patient's mobile device by the disclosed CBT application when used for smoking cessation. Smoking/Tobacco cessation can be treated by: Profiling the user's unique smoking behaviors; co-creating, with the user's participation, a plan to stop smoking; educating the patient about smoking dangers, medications to help with quitting, dealing with common side-effects of smoking cessation; setting goals and rewards for behavior change; and keeping the patient on track during the maintenance phase.

FIG. 10 illustrates example pages 700, 750, 800, 850 associated with the smoking cessation CBT functionality provided by the disclosed application (when executed on the patient's mobile device). Page 700 illustrates an example menu 702 providing the user with many of the options to set up, perform and monitor the smoking cessation CBT that the disclosed application prescribes for the patient. Page 750 illustrates an example menu 752 for the “Profile Menu” illustrated on page 700. The illustrated menu 752 includes pull down menus/descriptions for determining the patient's profile to be used with the application disclosed herein. For example, menu 752 includes an option 754 to help the patient determine “How Addicted Are You?”; an option 756 to select a “Medications Quiz”; an option 758 to help the patient determine his/her “Smoker Type Profile”; an option 760 for the patient to perform a “Self Assessment”; an option 762 to allow the user to “Change Plan”; and option 764 to allow the user to access a “Cost Calculator”; and option 766 to allow the user to “Reward Yourself” and an option 768 to allow the user to “Track Your Habit.”

Page 800 illustrates the “How Addicted?” questionnaire referred to in page 750. In the example, the questionnaire includes a question e.g., “How soon after you wake up do you smoke your first cigarette?” The page 800 includes selectors 802, 804, 806, 808 for selecting a typical patient response. Similarly, page 850 illustrates a medical survey. In this example, the page 850 includes the question “Have you tried Nicotine Replacement Therapy in conjunction with Bupropion?” A selector 852 is provided for a “yes” response and a selector 854 is provided for a “no”. FIG. 10 illustrates a “no” response being selected. It should be appreciated that the pages 700, 750, 800, 850 associated with smoking cessation could include other messages and quizzes deemed appropriate for the patient's CBT.

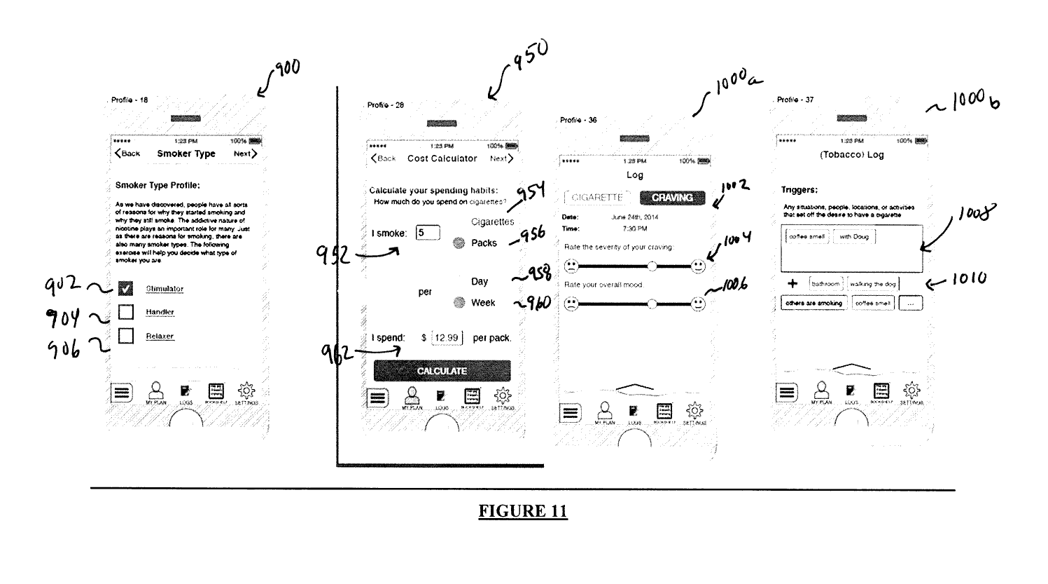

FIG. 11 illustrates additional example pages 900, 950, 1000a, 1000b associated with the smoking cessation CBT functionality provided by the disclosed application (when executed on the patient's mobile device). Page 900 illustrates fields 902, 904, 906 allowing the patient to input his/her opinion of the type of smoker he/she is (i.e., stimulator, handler, relaxer). As shown, each field 902, 904, 906 includes a selection box (with the box for field 902 being shown as selected) and a smoker type hyperlink in which the patient can click on to obtain a description of the type.

Page 950 illustrates an example cost calculator page allowing the patient to calculate his/her spending costs for the purchase of cigarettes. For example, one field 952 allows the patient to enter a numerical value that can represent the number of cigarettes (via selector 954) or packs (via selector 956) the patient smokes per day (via selector 958) or week (via selector 960). In the illustrated example, the patient has entered 5 packs per week using field 952 and selectors 956, 960. Field 962 allows the patient to enter a price for a pack of cigarettes, which allows the patient to click calculate to determine his/her costs spent on cigarette purchases for the day (via selector 958) or week (via selector 960).

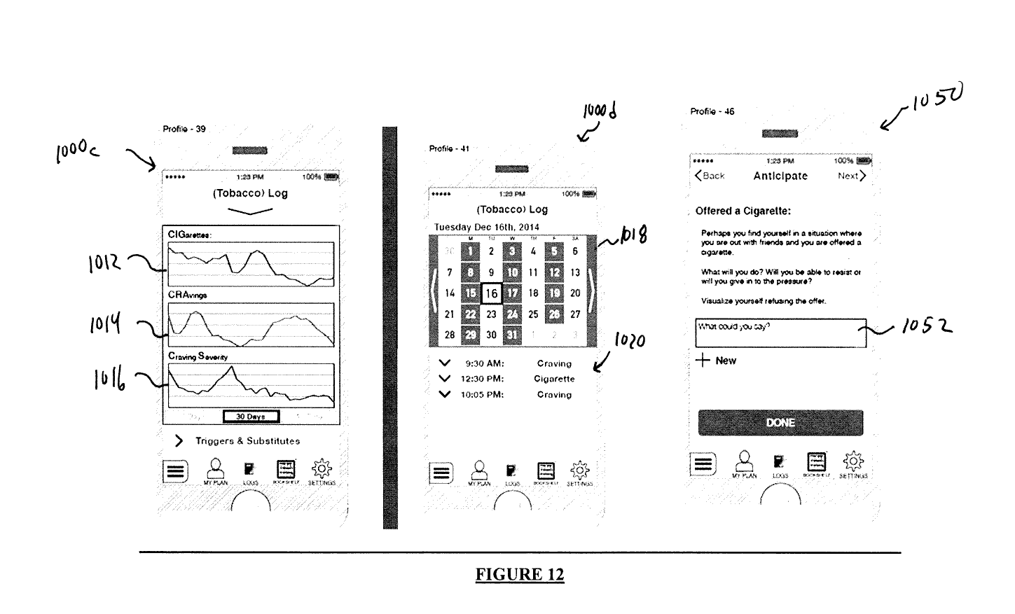

Pages 1000a, 1000b, 1000c (FIG. 12), 1000d (FIG. 12) are pages illustrating an example tobacco log. The log can be categorized as cigarette or craving via field 1002. Example page 1000a has one field 1004 allowing the user to rate his/her craving using a sliding scale and another field 1006 allowing the user to rate his/her mood using a similar sliding scale. Page 1000b includes a fields 1008, 1010 allowing the user to select or input triggers, which could be a situation, person, location, activity, etc. that sets off the desire to have a cigarette. Example page 1000c illustrates graphs 1012, 1014, 1016 respectively showing the patient's cigarette usage, cravings, and craving severity based upon user and other information input into the application. Page 1000d shows a calendar 1018 and times 1020 per a selected day in which the patient experienced a craving or smoked a cigarette. It should be appreciated that the pages 900, 950, 1000a, 1000b, 1000c, 1000d associated with smoking cessation could include other messages, menus and illustrations deemed appropriate for the patient's CBT.

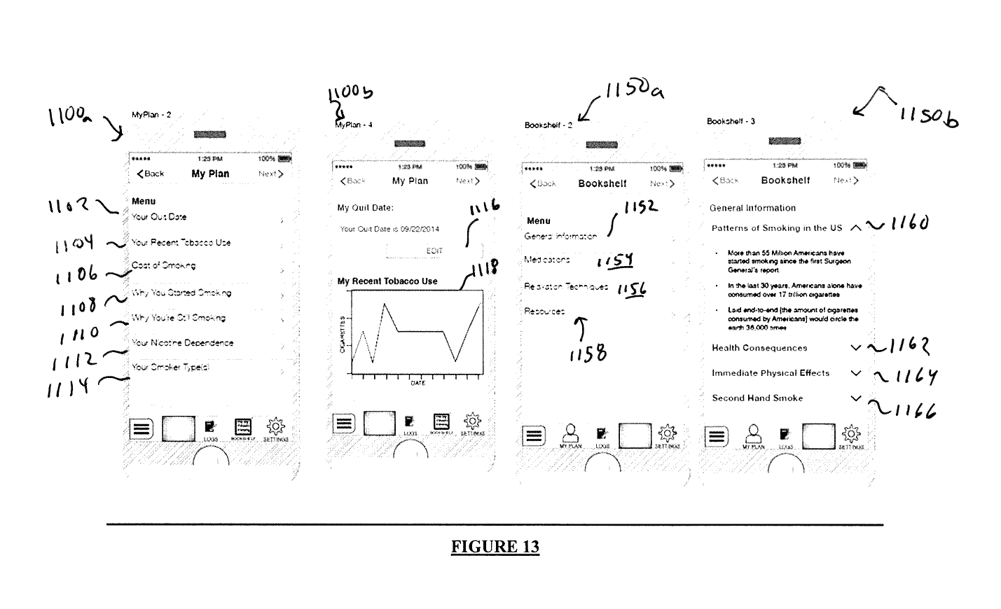

FIG. 12 also illustrates an example page 1050 denoted as “anticipate”, which posts a scenario that the patient may experience and has a field 1052 for the patient to input an expected response to the scenario. FIG. 13 illustrates two example “my plan” pages 1100a, 1100b and two example “bookshelf” pages 1150a, 1150b in accordance with the principles disclosed herein. Example page 1100a includes pull down menus/descriptions associated with the CBT plan developed by the application. For example, there is a menu option 1102 for the patient's quit date; option 1104 for the patient's tobacco usage; option 1106 for the patient's cost of smoking; option 1108 for the reason why the patient started smoking; option 1110 for the reason why the patient is still smoking; option 1112 for information on the patient's nicotine dependence; and option 1114 for the patient's smoker type. Page 1100b illustrates information associated with the patient's quit date. For example, there is a field 1116 to edit/modify the quit date and a chart 1118 showing the patient's recent tobacco usage.

Page 1150a illustrates a menu for the bookshelf page. In the illustrated example, there is an option 1152 to obtain general information related to smoking cessation; option 1154 for obtaining information about medications; option 1156 for obtaining information regarding relaxation techniques; and an option 1158 for obtaining access to other resources. Page 1150b illustrates features when “general information” is selected from page 1150a. The illustrated page 1150b includes an option 1160 related to patterns of smoking in the United States; option 1162 related to health consequences of smoking; option 1164 related to immediate physical effects; and option 1166 related to second hand smoke. It should be appreciated that the pages 1100a, 1100b, 1150a, 1150b associated with smoking cessation could include other messages, menus, illustrations and links to resources deemed appropriate for the patient's CBT.

FIG. 14 illustrates a medications quiz 1200a, 1200b that may be used to gather data used by CBT application in FIG. 3, for example. CBT application may present a survey 1202, receive user survey answers, and receive indication that the survey is complete 1204. CBT application may perform above-described analysis and provide functionality to allow the user to retake the quiz 1206 along with a recommended therapy 1208. User may be able to provide feedback about the therapy through a self-assessment 1210, for example providing feedback about whether the therapy is working and/or whether it is having other positive or negative effects on the user.

Some examples of the CBT application described above may incorporate therapy directly into the application in addition to and/or alternatively to providing recommendations for external therapies. For example, CBT application may perform processing as described above and determine that self-determination theory (SDT) and/or guided meditation are appropriate treatments to recommend.

SDT complements CBT by using framing and self-determinative messaging to make it easier for the user to develop the intrinsic motivation needed to both take on behavior change and stick with it after the program is over.

Guided meditation may include recordings of guided meditation sessions by a licensed practitioner designed to complement, extend, and further personalize the cognitive and self-determinative aspects of the CBT application. This may include a set of recorded components that together can be used to create a targeted guided meditation experience for each health condition. The components may include, for example:

1. Induction: using guided imagery to focus attention and block out thoughts.

2. Deepening: continued use of guided imagery, breathing techniques, etc. to further quiet the conscious mind and take the subject deeper.

3. Therapy: Connect directly with the subconscious mind with therapeutic suggestions that lead the subject to the desired outcome.

4. Wakening: Making the transition back to the conscious mind.

The disclosed principles translate an evidence-based tobacco cessation program, and Tobacco Tactics, into a mobile application. Mobile applications incorporate convenience and privacy and make it easier for people to track their habits and cravings. The disclosed CBT application can be used in conjunction with a healthcare provider or alone. Features of the disclosed CBT application for tobacco/smoking cessation include: (1) a profile section that uses several evidence-based clinical instruments to determine smoker type and set up a stop smoking plan; (2) smoking logs that establish baseline smoking habit and that allow a user to track progress towards becoming smoke-free. Logs track smoking incidents and triggers and allow for narrative comments. (Studies show that journaling is beneficial for improving health outcomes.); (3) a quitting section that helps the user create coping responses for challenging situations, including cognitive techniques for handling thoughts; (4) a maintenance section that covers withdrawal symptoms and side effects, offers tips and techniques for maintaining a tobacco-free lifestyle; (5) a “My Plan” section that gathers the results of all activities and questionnaires into a personalized plan for quitting; (6) a logs section that provides easy access to the important daily activity of noting triggers, cravings and smoking. These are then used to help tailor a personalized quitting program for the user; and (7) a bookshelf section that is a central location for reference information provided in the application. The CBT application may incorporate smokeless tobacco information and activities.

The disclosed CBT method, system and application will work as a substitute for CBT-Insomnia and Tobacco Cessation therapy with a human therapist. The disclosed principles present the therapy as a stepped process, in much the same way a therapist would. There is a beginning, middle, and an end phase to the therapy. This means the patient experiences the therapy in stages. At the same time that it is presenting a linear process of the progressive therapy for insomnia, the disclosed embodiments also leverage the native capabilities of a digital content to provide random access to the key tools of the therapy: a sleep log, including metrics and visualizations based on that information; a “bookshelf” for ready access to reference materials, a repository for quizzes and interactive features that can be taken multiple times, and My Plan, a place where all the key information about the user's program is quickly available. The disclosed application also uses native capabilities of the mobile device for reminders and encouragers.

The disclosed embodiments create a better experience that leads to better outcomes for the patient. People will not comply with any therapy (e.g., taking a pill, wearing a sleep apnea mask, etc.) if the experience is not beneficial. Medical applications create their own problems of getting too big and too wordy. The disclosed embodiments, however, reduce the use of multiple log menus and instead create one environment that uses features like “collapsible” screens and pull-out or swipe functions. The disclosed embodiments use less Yes-No questions, and more use tag features. The disclosed embodiments use the right amount of personalization and super-customization on one screen.

Typical CBT systems and methods prompt the user with simplistic “reward yourself with each urge to overcome” that is believed to be too general and vague. The disclosed embodiments give a list of prompts that a patient rewards itself and looks back at their personalization. In sum, the disclosed embodiments combine both linear and non-linear presentations for maximum usefulness of a therapeutic application, which allows each user to move through the therapy at its own pace. The user can always access any section of the therapy to preview or review its contents. The process is presented in a flexible fashion, giving the user a sense of control over the experience.

The disclosed embodiments link with the native capabilities of the mobile device, including access to media players, calendar and reminders, email and texting, posting to social networks, and pulling images from the camera for motivation. The disclosed embodiments have the capability to connect with a tracking device via Bluetooth to download sleep metrics. The devices can be a sleep quality tracker and potentially other activity trackers on the market such as e.g., the Fitbit, Fuel Band or Jawbone Up. While the disclosed embodiments can be used in a standalone fashion, they can also be used as part of a platform that links individual patients and their applications with a healthcare system via a HIPPA compliant, cloud based telemedicine system. The disclosed embodiments can be integrated with a mobile health cloud system/telemedicine system such as e.g., the one developed by Zansors. Key features include: 1) self-reporting data from the patient using the application; 2) a cloud analytics database that can handle unstructured data; 3) a health dashboard to share with a care coordination team (physician, nurse, sociologist, physical therapist, etc.) and 4) security and HIPAA/privacy compliance. Medical providers will have access to patient metrics, will be able to set thresholds for each patient, and will be able to reach out directly to the patient if need be.

What is special/different/novel/non-obvious about the disclosed embodiments? The disclosed embodiments present CBT in a progression of sessions, much like in-person CBT therapy does. They are flexible, and allow the user to be in control and take sessions whenever they want to (e.g., jump around, see what's ahead, etc.). The disclosed embodiments present narrative information in interactive format, with instructional quizzes rather than articles. The disclosed embodiments provide greater clarity around the sleep restriction part of the program. The disclosed embodiments employ significantly better, more understandable visualizations of the data, including tagging which is integrated with visualizations so user has a better sense of the factors that may be influencing sleep amount and quality, smoking triggers, etc. The disclosed embodiments offer journaling, which has therapeutic as well as interpretive value; incorporates screening for 2 top sleep pathologies at the start, Apnea and RLS, using standard instruments. Moreover, CBT is not appropriate for people with these sleep diseases. Accordingly, the disclosed embodiments will identify people at risk for these diseases so they can get the care they need right away.

It should be appreciated that the examples set forth herein are provided merely for the purpose of explanation and are in no way to be construed as limiting. While reference to various embodiments is made, the words used herein are words of description and illustration, rather than words of limitation. Further, although reference to particular means, materials, and embodiments are shown, there is no limitation to the particulars disclosed herein. Rather, the embodiments extend to all functionally equivalent structures, methods, and uses, such as are within the scope of the appended claims.

Additionally, the purpose of the Abstract is to enable the patent office and the public generally, and especially the scientists, engineers and practitioners in the art who are not familiar with patent or legal terms or phraseology, to determine quickly from a cursory inspection the nature of the technical disclosure of the application. The Abstract is not intended to be limiting as to the scope of the present inventions in any way.

1. A computer implemented method for implementing cognitive behavioral therapy (CBT) for a patient, said method comprising:
inputting a patient profile via an application executing on a processor of a patient device, said application being adapted to input data directly from the patient and from one or more wearable electronic devices associated with the patient;
analyzing the profile to generate a CBT plan for the patient;
monitoring patient data and other input data obtained as the patient implements the CBT plan to determine a status of the CBT plan; and
determining if the CBT requires adjustment based on the monitored patient data and other input data.

2. The method according to claim 1, wherein the one or more wearable electronic devices comprises one or more of health monitors, exercise monitors, sleep monitors, sleep apnea sensors/monitors, breathing sensors, or heart rate monitors.

3. The method according to claim 1, wherein future stages of the CBT plan can be analyzed, adjusted or skipped based on inputs from the patient or data from the one or more wearable electronic devices associated with the patient.

4. The method according to claim 1, wherein information used to generate and monitor the CBT plan is received from a server computer over a network connection.

5. The method according to claim 1, wherein information used to generate and monitor the CBT plan is received from one of a camera or accelerometer of the patient device.

6. The method according to claim 1, wherein information from the application is transmitted from the patient's device to a cloud based health monitoring system.

7. The method according to claim 1, further comprising reporting a status of how the patient is progressing through the CBT plan via one of messages or graphical illustrations of one or more parameters of the CBT plan.

8. The method according to claim 1, wherein the application provides a log function and information input into the log is used to assess the status of the CBT plan.

9. The method according to claim 1, wherein said application comprises one or more of a behavior portion adapted to educate the patient about enhancing behaviors, a cognitive portion adapted to address unhelpful thinking, a maintenance portion adapted to create a personalized reference and provide tips for handling lapses or an electronic bookshelf portion adapted to provide a central location for reference information provided by the application.

10. The method according to claim 1, wherein the CBT plan is used to treat insomnia.

11. The method according to claim 1, wherein the CBT plan is used to treat smoking addiction.

12. A system for implementing cognitive behavioral therapy (CBT) for treating a patient, said system comprising:
an application program to be executed by a processor of a patient device, said application being adapted to:
input a patient profile by inputting data directly from the patient and from one or more wearable electronic devices associated with the patient;
analyze the profile to generate a CBT plan for the patient;
monitor patient data and other input data obtained as the patient implements the CBT plan to determine a status of the CBT plan; and
determine if the CBT requires adjustment based on the monitored patient data and other input data.

13. The system according to claim 12, wherein the one or more wearable electronic devices comprises one or more of health monitors, exercise monitors, sleep monitors, sleep apnea sensors/monitors, breathing sensors, or heart rate monitors.

14. The system according to claim 12, wherein future stages of the CBT plan can be analyzed, adjusted or skipped based on inputs from the patient or data from the one or more wearable electronic devices associated with the patient.

15. The system according to claim 12, further comprising a server computer, and wherein information used to generate and monitor the CBT plan is received from the server computer over a network connection.

16. The system according to claim 12, wherein information from the application is transmitted from the patient's device to a cloud based health monitoring system.

17. The system according to claim 12, wherein the application is further adapted to report a status of how the patient is progressing through the CBT plan via one of messages or graphical illustrations of one or more parameters of the CBT plan.

18. The system according to claim 12, wherein the application provides a log function and information input into the log is used to assess the status of the CBT plan.

19. The system according to claim 12, wherein said application comprises one or more of a behavior portion adapted to educate the patient about enhancing behaviors, a cognitive portion adapted to address unhelpful thinking, a maintenance portion adapted to create a personalized reference and provide tips for handling lapses or an electronic bookshelf portion adapted to provide a central location for reference information provided by the application.

20. The system according to claim 12, wherein the CBT plan is used to treat one of insomnia or smoking addiction.
